(19) United States
(12) Patent Application Publication
(10) Pub. No.: US 2006/0133401 A1
(43) Pub. Date: Jun. 22, 2006

(54) Communication apparatus, wireless communication terminal, wireless communication system, and wireless communication method

(75) Inventors: Kotaro Ise, Saitama-shi (JP); Shuichi Sekine, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/265,185

(22) Filed: Nov. 3, 2005

(30) Foreign Application Priority Data
Dec. 20, 2004 (JP) 2004-367317

(51) Int. Cl. H04L 12/54; H04J 1/16

(52) U.S. Cl. 370/428; 370/252

(57) ABSTRACT

Disclosed is a communication apparatus including: an estimating unit which estimates a first wireless channel state from a first frame wirelessly received and a second wireless channel state from a second frame wirelessly received after the first frame; a storing unit capable of storing the first wireless channel state as a past wireless channel state; a comparing unit which compares a difference between the second wireless channel state and the past wireless channel state with a threshold value; and a processing unit which discards the second frame when the difference is larger than the threshold value.

### CROSS-REFERENCE TO RELATED APPLICATIONS

This application is based upon and claims the benefit of priority from the prior Japanese Patent Application No. 2004-367317, filed on Dec. 20, 2004; the entire contents of which are incorporated herein by reference.

### BACKGROUND OF THE INVENTION

1. Field of the Invention

The present invention relates to a communication apparatus, a wireless communication terminal, a wireless communication system, and a wireless communication method, and particularly relates to a communication apparatus, a wireless communication terminal, a wireless communication system, and a wireless communication method which performs transmission/reception of packetized information.

2. Description of the Related Art

Wireless systems complying with standards defined by IEEE 802.11a, IEEE 802.11b, or IEEE 802.11g are used for LANs (local area networks) in business organizations and universities. Terminals exchange an association request frame and an association response with an access point to establish a connected relationship and thereafterperformtransmission/receptionof communicationdatavia that access point.

In the IEEE 802.11a, IEEE 802.11b, or IEEE 802.11g standard, data frames (data packets) can be encrypted by WEP (wired equivalent privacy) method, WPA (wired protect access) method, or the like, but management frames (management packets) cannot be encrypted. A management frame includes an association release request frame or anauthenticationreleaserequestframe. Consequently,oneterminal B can impersonate another legitimate terminal A and transmit an association release request frame to an access point, thereby releasing the connected relationship between the terminal A and the access point and interfering communication of the terminal A, which is a problem that needs be solved.

The frame format of a wireless MAC (media access control) frame is a line of fields of frame control, duration/ID, destination address, transmitting end address, BSSID, sequence control, frame body, and FCS in order. The wireless MAC frame is a common format for management frames, the control frames, and the data frames.

The frame control field has a type and a sub-type field and represents the type of a frame. For example, in an association release request, the type has a value 00, and the sub-type has a value 1010. Theduration/IDfieldisused in NAV(network allocation vector) setting for a carrier sense. In the destination address field, the MAC address of a destination of a frame is set, and under the above-described situation of interference, the MAC address of an access point is set. In the transmitting end address field, the MAC address of a terminal or an access point which has transmitted a frame is set, and under the above-described situation of interference, although the terminal B transmits the frame, the value of the MAC address of the terminal A is set.

In the BSSID field, the MAC address of an access point is set. In the sequence control field, the sequence number of a frame is set. In the frame body field, main body data of a frame is set, and in the case of the association release request frame, a reason code is set. In the FCS field, an error detection code is set.

By transmitting to the access point an association release request, in which the MAC address of the terminal A is written as a transmitting end address and the address of the access point is written as a destination address, the terminal B can release the connected relationship between the terminal A and the access point, and thus it is possible to interfere communication of the terminal A.

In recent years, methods for preventing attacks to a wireless terminal have been proposed. For example, in a technique disclosed in Patent Document 1 listed below (Kyocera Corporation, “Radio Communication Equipment”), when a large amount of packets are sent to awireless terminal to thereby make it unable to communicate, the wireless terminal changes its IP (internet protocol) address so that it can avoid receiving the large amount of packets. Thus, interference in communication is prevented. However, in this technique, attacks by means of transmitting an unauthorized management frame such as the above-described one cannot be prevented.

On the other hand, in recent years, a wireless technique called MIMO (multi input multi output) has been proposed. This is a technique such that a transmitting end transmits data using plural antennas, anda receiving end receives the data using plural antennas. Here, when the transmitting end has N number of antennas, the receiving end has M number of antennas, and L number of symbols is transmitted/received therebetween, the following relationship is established between them where a k-th symbol transmitted by the transmitting end via an n-th antenna is X(k, n), and a k-th symbol received by the transmitting end via an m-th antenna is Y(k, m).
<Y_{—}m>=<X><H_{—}m>+<W_{—}m>
Here, <Y_m> is a vector L×1 of [Y(1, m), Y(2, m), . . . , Y(L, m)]ˆT (<A>ˆT denotes the transpose of the matrix <A>).
<X> is a transmission symbol matrix L×NL of [diag(<X_1>), diag(<X_2>), . . . , diag(<X_N>)]. (diag( ) denotes a diagonal matrix.) <H_m>is a channel vector NL×1 of [H(1, 1, m), H(1, 2, m), . . . , H(1, N, m), H(2, 1, m), H(2, 2, m), . . . , H(2, N, m), . . . , H(L, N, m)]ˆT. H(k, n, m) is a channel gain between the transmitting antenna n and the receiving antenna m at the time of receiving a k-th symbol. <W_m>is a vector L×1 of [W(1, m), W(2, m), . . . , W(L, m)]ˆT. W(k, m) is noise in an m-th antenna at the time of receiving a k-th symbol.

In the MIMO technique, known symbols (referred to as a preamble) is transmitted/received per each transmitting frame between a transmitting terminal and a receiving terminal. The receiving terminal estimates an estimation value <H′>of <H>from the preamble, and draws a transmission symbol from a symbol in a frame received continuously from the preamble using the estimated <H′>. <H>is amatrixof N×M, and its element H(n, m) is an estimated communication gain between the transmitting antenna n and the receiving antenna m. How to obtain <H′> is described in detail, for example, in “Cannel Estimation and Data Detection in MIMO System UsingSAGEAlgorithm” (Sometani, Otsuki, TokyoUniversityof Science, Shingakugiho RSC2004-61).

Also, a technique for a receiver to estimate the direction of a transmitter using an array antenna has been developed. For example, in the contents disclosed in Patent Document 2 (Communication Research Laboratory, “Antenna Directivity Controller”) listed below, angle widths of incoming waves via multiple paths are measured, and the direction of an incoming wave having the smallest angle width is determined to be the direction of a transmitting terminal. Also, in the contents disclosed in Patent Document 3 (Matsushita Electric Industrial Co., Ltd, “Adaptive Antenna System”) listed below, the direction of an incoming wave having the smallest angle width among incoming waves having signal power of a constant value or larger is determined to be the direction of a transmitting terminal

[Patent Document 1] Japanese Patent Laid-open Application No. 2003-298763

[Patent Document 2] Japanese Patent Laid-open Application No. 2003-69481

[Patent Document 3] Japanese Patent Laid-open Application No. 2002-368663

As described above, a communication method which allows a terminal to establish a connected relationship with one of access points prior to communication, such as standards of IEEE 802.11a, IEEE 802.11b, or IEEE 802.11g has a problem that needs to be solved such that when an association release request frame or an authentication release request frame is transmitted from another terminal, a connected relationship with the access point is released even during encrypted communication, and thus the communication is interrupted.

### BRIEF SUMMARY OF THE INVENTION

The present invention is made in view of the above-described situation, and an object thereof is to provide a communication apparatus, a wireless communication terminal, a wireless communication system, and a wireless communication method in which a connected relationship between an access point and a terminal is not released by transmission of a management frame from another terminal.

A communication apparatus according to one aspect of the present invention includes: an estimating unit which estimates a first wireless channel state from a first frame wirelessly received and a second wireless channel state from a second frame wirelessly received after the first frame; a storing unit capable of storing the first wireless channel state as a past wireless channel state; a comparing unit which compares a difference between the second wireless channel state and the past wireless channel state with a threshold value; and a processing unit which discards the second frame when the difference is larger than the threshold value.

Further, a wireless communication terminal according to one aspect of the present invention includes: an estimating unit which estimates a first wireless channel state from a first frame wirelessly received and a second wireless channel state from a second frame wirelessly received after the first frame; a storing unit capable of storing the first wireless channel state as a past wireless channel state; a comparing unit which compares a difference between the second wireless channel state and the past wireless channel state with a first threshold value; and a processing unit which discards the second flamewhen the difference is larger than the first threshold value.

Further, a wireless communication system according to one aspect of the present invention includes: a communication apparatus which has a first estimating unit which estimates a first wireless channel state from a first frame wirelessly received and a second wireless channel state from a second frame wirelessly receivedafter the first frame, a first storing unit capable of storing the first wireless channel state as a first past wireless channel state, a first comparing unit which compares a first difference between the second wireless channel state and the first past wireless channel state with a first threshold value, and a first processing unit which discards the second frame when the first difference is larger than a first threshold value; and a terminal which has a second estimating unit which estimates a third wireless channel state from a third frame wirelessly received and a fourth wireless channel state from a fourth frame wirelessly received after the third frame, a second storing unit capable of storing the third wireless channel state as a second past wireless channel state, a second comparing unit which compares a seconddifferencebetween the fourthwireless channel state and the second past wireless channel state with a second threshold value, and a second processing unit which discards the fourth frame when the second difference is larger than a second threshold value, wherein the communication apparatus wirelessly transmits the third frame and the fourth frame, and wherein the terminal wirelessly transmits the first frame and the second frame.

Specifically, in these communication apparatus, wireless communication terminal, and wireless communication system, when an estimation result of a channel state is different from a previous estimation result by a predetermined threshold value or more, a frame wirelessly received in a channel state of the new estimation result can be discarded. Therefore, a connected relationship will not be released by a frame from an impersonating communication apparatus or wireless communication terminal.

Further, a wireless communication method according to one aspect of the present invention includes: estimating a first wireless channel state by an estimating unit from a first frame wirelessly received and a second wireless channel state by the estimating unit from a second frame wirelessly received after the first frame; storing the first wireless channel state as a past wireless channel state; comparing a difference between the second wireless channel state and the past wireless communication with a threshold value; and discarding the second frame when the difference is larger than the threshold value. According to this method, the same effect as the above-described communication apparatus or wireless communication terminal can be obtained by the same operation thereof.

Further, a communication apparatus according to another aspect of the present invention includes: an estimating unit which estimates a radio wave incoming direction from a condition of a radio wave. wirelessly received; a processing unit which creates a frame including the radio wave incoming direction; and a transmitting/receiving unit which transmits the frame via wired transmission.

Further, a communication apparatus according to still another aspect of the present invention includes: a storing unit capable of storing first radio wave incoming directions, as past radio wave incoming directions, included in first frames transmitted via the wired transmission from the two access points respectively; a comparing unit which compares a difference between a first terminal location by the past radio wave incoming directions and a second terminal location by second radio wave incoming directions included in second frames transmitted via the wired transmission from the two access points after the first frames with a threshold value; a processing unit which creates a reply frame for the second frames only when the difference is not larger than a threshold value; and a transmitting/receiving unit which transmits the reply frame via the wired transmission to predetermined one of the two access points.

Further, a wireless communication system according to another aspect of the present invention includes: first and second communication apparatuses each of which has an estimating unit which estimates a first radio wave incoming direction from a first condition of a first radio wave wirelessly received and a second radio wave incoming direction from a second condition of a second radio wave wirelessly received after the first radio wave, a processing unit which creates a first frame including the first radio wave incoming direction and a second frame including the second radio wave incoming direction, and a transmitting/receiving unit which transmits the first frame via wired transmission and the second frame via wired transmission respectively, the first and second communication apparatuses being placed at locations different from each other; and a third communication apparatus which comprises a storing unit capable of storing the first radio wave incoming directions, as past radio wave incoming directions, included in the first frames transmitted via wired transmission from the first and second communication apparatuses respectively, an comparing unit which compares a difference between a first terminal location by the past radio wave incoming directions and a second terminal location by the second radio wave incoming directions included in the second frames with a threshold value, a processing unit which creates a reply frame for the second frames only when the difference is not larger than the threshold value, and a transmitting/receiving unit which transmits the reply frame via wired transmission to predetermined one of the first and second communication apparatuses.

Specifically, in these communication apparatus and wireless communication system, when a terminal location obtained from estimated incoming directions of radio waves at two communication apparatuses is different from a previous terminal location by a predetermined threshold value or more, it is possible to prevent generation of a response to a frame wireles sly received from a terminal at the new terminal location. Therefore, a connected relationship will not be released by a frame from an impersonating wireless communication terminal.

Further, a wireless communication method according to another aspect of the present invention includes: in first and second communication apparatuses placed at locations different from each other, estimating a first radio wave incoming direction from a first condition of a first radio wave wirelessly received and a second radio wave incoming direction from a second condition of a second radio wave wirelessly received after the first radio wave, creating a first frame including the first radio wave incoming direction and a second frame including the second radio wave incoming direction, and transmitting the first frame via wired transmission and the second frame via wired transmission respectively; storing the first radio wave incoming directions, as past radio wave incoming directions, included in the first frames transmitted via wired transmission from the first and second communication apparatuses respectively; comparing a difference between a first terminal location by the past radio wave incoming directions and a second terminal location by the second radio wave incoming directions included in the second frames with a threshold value; creating a reply frame for the second frames only when the difference is not larger than the threshold value; and transmitting the reply frame via wired transmission to predetermined one of the first and second communication apparatuses. According to this method, the same effect as the above-described wireless communication system can be obtained by the same operation thereof.

Further, a communication apparatus according to yet another aspect of the present invention includes: an estimating unit which estimates a first radio wave incoming direction from a first condition of a first radio wave wirelessly received and a second radio wave incoming direction from a second condition of a second radio wave wirelessly received afterthe first radiowave; a storing unit capable of storing the first radio wave incoming direction and a third radio wave incoming direction included in a first frame transmitted via wiredtransmission as past radiowave incoming directions; a comparing unit which compares a difference between a first terminal location by the past radio wave incoming directions and a second terminal location by the second radio wave incoming direction and a fourth radio wave incoming direction included in a second frame transmitted via wired transmission after the first frame with a threshold value; and a processing unit which discards information included in the second radio wave when the difference is larger than a threshold value.

Further, a wireless communication system according to still another aspect of the present invention includes: a first communication apparatus which has a first estimating unit which estimates a first radio wave incoming direction from a first condition of a first radio wave wirelessly received and a second radio wave incoming direction from a second condition of a second radio wave wirelessly received after the first radio wave, a first processing unit which creates a first frame including the first radio wave incoming direction and a second frame including the second radio wave incoming direction, and a transmitting/receiving unit which transmits the first frame via wired transmission and the second frame via wired transmission respectively; and a second communication apparatus which is located at a position different from the first communication apparatus and has a second estimating unit which estimates a third radio wave incoming direction from a third condition of a third radio wave wirelessly received and a fourth radio wave incoming direction from a fourth condition of a fourth radio wave wirelessly received after the third radio wave, an storing unit capable of storing the third radio wave incoming direction and the first radio wave incoming direction included in the first frame transmitted via wired transmission from the first communication apparatus as past radio wave incoming directions, an comparing unit which compares a difference between a first terminal location by the past radio wave incoming directions and a second terminal location by the fourth radio wave incoming direction and the second radio wave incoming direction included in the second frame transmitted viawiredtransmissionwithathresholdvalue, andasecondprocessing unit which discards information included in the second radio wave when the difference is larger than a threshold value.

Specifically, in these communication apparatus and wireless communication system, when a terminal location obtained from estimated incoming directions of radio waves at two communication apparatuses is different from a previous terminal location by a predetermined threshold value or more, it is possible to prohibit generation of a response to a frame wirelessly received from a terminal at the new terminal location. Therefore, a connected relationship will not be released by a frame from an impersonating wireless communication terminal.

Further, a wireless communication method according to yet another aspect of the present invention includes: in a first communication apparatus, estimating a first radio wave incoming direction from a first condition of a first radio wave wirelessly received and a second radio wave incoming direction from a second condition of a second radio wave wirelessly received after the first radio wave, creating a first frame including the first radio wave incoming direction and a second frame including the second radio wave incoming direction, and transmitting the first frame via wired transmission and the second frame via wired transmission respectively; and in a second communication apparatus which is located at a position different from the first communication apparatus, estimating a third radio wave incoming direction from a third condition of a third radio wave wirelessly received and a fourth radio wave incoming direction from a fourth condition of a fourth radio wave wirelessly received after the third radio wave, storing the third radio wave incoming direction and the first radio wave incoming direction included in the first frame transmitted via wired transmission from the first communication apparatus as past radio wave incoming directions, comparing a difference between a first terminal location by the past radio wave incoming directions and a second terminal location by the fourth radio wave incoming direction and the second radio wave incoming direction included in the second frame transmitted via wired transmission with a threshold value, and discarding information included in the second radio wave when the difference is larger than a threshold value. According to this method, the same effect as the above-describedwireless communication system can be obtained by the same operation thereof.

According to the present invention, it is possible to provide a communication apparatus, a wireless communication terminal, a wireless communication system, and a wireless communication method in which a connected relationship between an access point and a terminal is not released by transmission of a management frame from another terminal.

### BRIEF DESCRIPTION OF THE SEVERAL VIEWS OF THE DRAWINGS

FIG. 1 is a block diagram showing a schematic configuration of a wireless communication system according to an embodiment of the present invention.

FIG. 2 is a view showing a wireless MAC frame format issued by a wireless terminal 14 (15, 16) shown in FIG. 1 and an access point 12 shown in FIG. 1.

FIG. 3 is a view showing the configuration of a physical frame transmitted/received between the wireless terminal 14 (15, 16) and the access point 12 shown in FIG. 1.

FIG. 4 is a flowchart showing a schematic flow of the operation of the access point 12 and the wireless terminal 14 (15, 16), which are shown in FIG. 1.

FIG. 5 is a block diagram showing a configuration example of the access point 12 shown in FIG. 1.

FIG. 6 is a block diagram showing a configuration example of the wireless terminal 14 (15, 16) shown in FIG. 1.

FIG. 7 is a block diagram showing a schematic configuration of a wireless communication system according to another embodiment of the present invention.

FIG. 8 is a view showing a format example of an access point control frame transmitted by access points 12A, 12B shown in FIG. 7 to a managing apparatus 71.

FIG. 9 is a view showing a format example of an access point control frame returned by the managing apparatus 71 shown in FIG. 7 to the access point 12A.

FIG. 10 is a flowchart showing a schematic flow of the operation of the managing apparatus 71 shown in FIG. 7.

FIG. 11 is a block diagram showing a configuration example of the access points 12A, 12B shown in FIG. 7.

FIG. 12 is a block diagram showing a configuration example of the managing apparatus 71 shown in FIG. 7.

FIG. 13 is a block diagram showing a schematic configuration of a wireless communication system according to still another embodiment of the present invention.

FIG. 14 is a block diagram showing a configuration example of an access point 12C shown in FIG. 13.

FIG. 15 is a block diagram showing a configuration example of an incoming direction notifying apparatus 121 shown in FIG. 13.

### DETAILED DESCRIPTION OF THE INVENTION

### DESCRIPTION OF THE EMBODIMENTS

Embodiments of the present invention will be described with reference to the drawings, but these drawings are provided only for an illustrative purpose and in no way limit the present invention.

As a mode of an embodiment of the present invention, it is possible that the storing unit stores the second wireless channel state as the past wireless channel state when the difference is not larger than the threshold value. By storing, comparison on the next timing can be performed continuously.

Further, as a mode of an embodiment of the present invention, it is possible that, the channel state estimating unit uses previously known symbols included in the frame so as to estimate a wireless channel state from a wirelessly received frame. This is an example for estimating a channel state in view of current standards.

Further, as a mode of an embodiment of the present invention as a wireless communication terminal, it is also possible that the storing unit stores the second wireless channel state as the past wireless channel state when the difference is not larger than the first threshold value. Moreover, it is possible that, for estimating a wireless channel state from a wirelessly received frame, the channel state estimating unit uses previously known symbols included in the frame.

Further, a mode of an embodiment of the present invention as the wireless communication terminal may further include a transmitting/receiving unit capable of wirelessly transmitting a third frame periodically. Thereby, it is possible to appropriately cope with a case that the wireless communication terminal moves.

Further, as a mode of an embodiment of the present invention as the wireless communication terminal, it is possible that the estimating unit further estimates a third wireless channel state from a beacon frame wirelessly received after the first frame, the comparing unit further compares a second difference between the third wireless channel state and the past wireless channel state with a second threshold value which is smaller than the first threshold value, and the wireless communication terminal further comprises a transmitting/receiving unit which wirelessly transmits a third frame when the second difference is larger than the second threshold value. Instead of transmitting a frame periodically, a wireless channel state is estimated with a periodically transmitted beacon frame to detect movement of a terminal thereof, and the frame is wirelessly transmitted when the movement is detected. Thereby, it is possible also to appropriately cope with a case that the wireless communication terminal moves.

Further, it is possible that the incoming direction comparing unit sends the new radio wave incoming directions to the incoming direction storing unit when as a result of the comparison a difference therebetween is judged to be not larger than the threshold value, and the incoming direction storing unit overwrites the sent new radio wave incoming directions on the stored radio wave incoming directions. By overwriting, comparison on the next timing can be performed continuously.

### First Embodiment

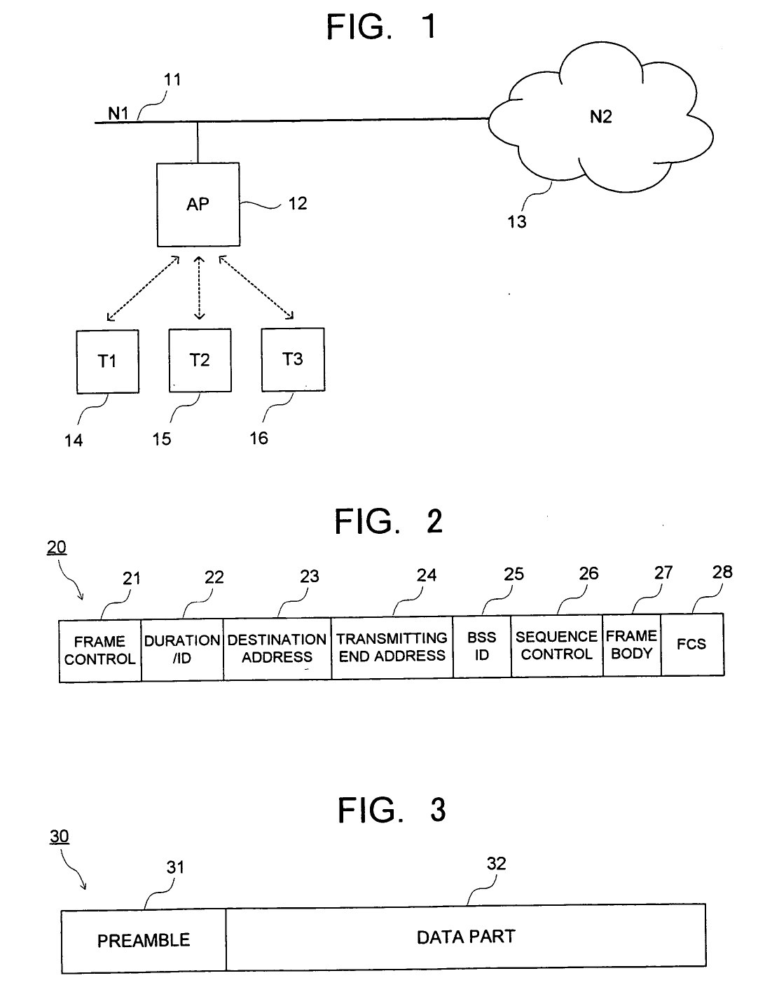

In view of the above, embodiments of the present invention will be described below with reference to the drawings. FIG. 1 is a block diagram showing a schematic configuration of a wireless communication system according to an embodiment of the present invention. As shown in FIG. 1, this system has a network 11 (N1), an access point 12 (AP), an outside network 13 (N2), and wireless terminals 14 (15, 16, . . . ) (Ti to T3). Here, the access point 12 is equivalent to acommunication apparatus, and the wireless terminals 14 (15, 16, . . . . ) are equivalent to wireless communication terminals.

The access point 12 is connected to the network 11 and is capable of communicating also with the outside network 13 via the network 11. The wireless terminal 14 (15, 16) is capable of connecting to the access point 12 wirelessly and thereby capable of communicating via the access point 12 with another terminal. Further, the wireless terminal 14 (15, 16) is capable of communicatingalso with a terminal on the outside network 13 via the access point 12 and the network 11.

The network 11 is a LAN configured typically by IEEE 802.3 Ethernet (Ethernet is a registered trademark). Communication between the access point 12 and the wireless terminal 14 (15, 16) is carried out typically using the MIMO technique. In this embodiment, MIMO is presented as an example, but it may be other than MIMO as long as it is a communication technique for estimating a state of a channel.

When the wireless terminal 14 (15, 16) attempts to perform some kind of communication, it sends an association request to the access point 12 to which it desires to be connected. Responding to this, an association response is issued from the access point 12, and when the wireless terminal 14 (15, 16) receives this response, a connected relationship is established between the wireless terminal 14 (15, 16) and the access point 12. A frame format of the association request has a configuration shown in FIG. 2 for example. FIG. 2 is a view showing a frame format of the association request issued by the wireless terminal 14 (15, 16) shown in FIG. 1 and a frame format of the association response issued by the access point 12 shown in FIG. 1.

The association request/response frame format 20 in association request has fields with the following values.
Frame control field 21=(type=00, sub-type=0000)
Destination address field 23=MAC address of the access point 12
Transmitting end address field 24=MAC address of the wireless terminal 14 (15, 16)
BSSID field 25=MAC address of the access point 12
Frame body field 27=identifier of ESS desired to be connected Incidentally, a duration/ID field 22 is used for NAV (network allocation vector) setting of a carrier sense. In a sequence control field 26, the sequence number of a frame is set. In an FCS field 28, an error detection code is set.

Also, the association request/response frame format 20 in association response has fields with the following values.
Frame control field 21=(type=00, sub-type=0001)
Destination address field 23=MAC address of the wireless terminal 14 (15, 16)
Transmitting end address field 24=MAC address of the access point 12
BSSID field 25=MAC address of the access point 12
Frame body field 27=possibility of connection
   The remaining fields 22, 26, 28 are the same as those in the case of the association request frame.

The wireless terminal 14 (15, 16) and the access point 12 is able to transmit/receive data after establishing the connected relationship. This transmission/reception is performed via an antenna (not shown) by means of a physical frame having as a physical layer a configuration shown in FIG. 3. FIG. 3 is a view showing the configuration of the physical frame transmitted/received between the wireless terminal 14 (15, 16) and the access point 12 shown in FIG. 1. The head of the physical frame 30 is a preamble 31, and a subsequent data part 32 corresponds to a wireless MAC frame.

The preamble 31 is known symbols between a transmitting end and a receiving end, and a channel state can be estimated using this preamble 31. For example, when the MIMO technique in which both the transmitting end and the receiving end has Mnumber of antennas is used, the receiving end can estimate the state <H′> of a channel from received signals row <Y> and preamble symbols row <X>. Here, <Y> is an L×M matrix with elements Y(k, m), and Y(k, m) is a k-th preamble symbol received by an antenna m. L is a length of the preamble, <X> is an L×M matrix with elements X(k, m), and X(k, m) is a k-th transmitted preamble symbol that should have been transmitted from an antenna m. The <H′> is an estimation value for <H>, and <H> is a matrix M×M with elements H (n, m) being an estimated communication gain between a transmitting antenna n and a receiving antenna m.

The access point 12 or the wireless terminal 14 (15, 16) estimates a channel state <H′> of every physical frame and derives transmitting symbols of the data part in the physical frame using <H′> obtained by estimation. Then, it compares achannel state <H′_p> at the time of receiving a previous physical frame with the channel state <H′> at this time, and if the channel state is different largely, it recognizes the channel state as unauthorized data from a false transmitter and discards the received data. Whether to discard the data or not here can be determined by, for example, the following value A.
A=Σ|H′ (n, m)−H′_{—}p(n, m)| (where n=1 to N, m=1 to M, and |X| denotes the absolute value of X) [equation 1]
Here, if A>α, data is discarded. Otherwise, data is accepted.

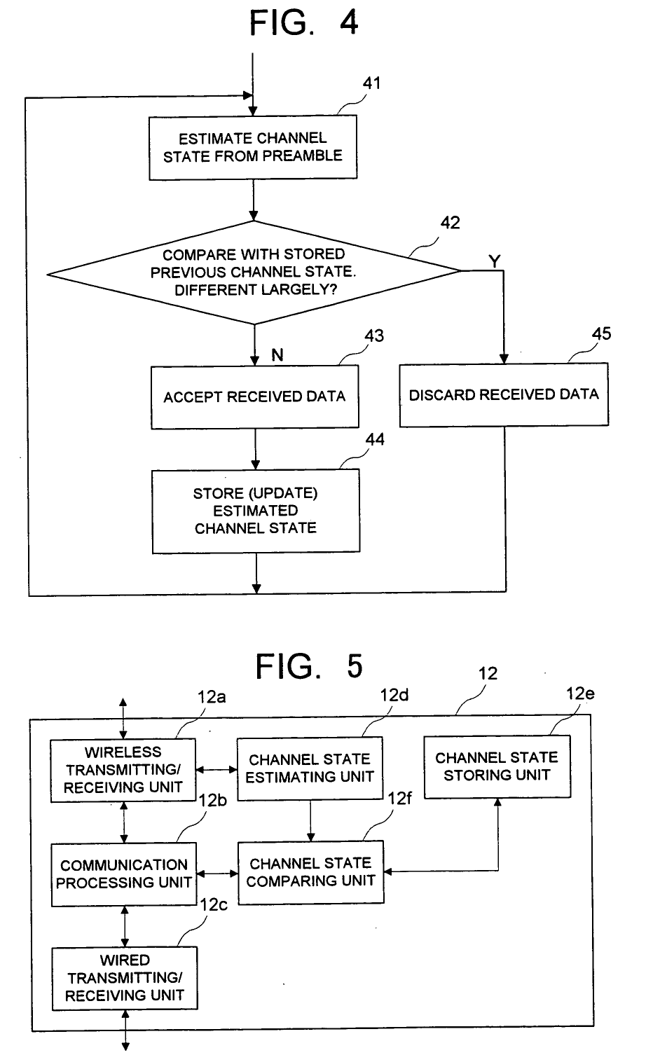

Description of the above operation in a flow is shown in FIG. 4. FIG. 4 is a flowchart showing a schematic flow of the operation of the access point 12 or the wireless terminal 14 (15, 16), which are shown in FIG. 1. Specifically, the wireless terminal 14 (15, 16) or the access point 12 estimates, when a physical frame is received, a channel state <H′> from a preamble thereof (Step 41), and compares <H′> obtained by the estimation with a stored channel state <H′_> (Step 42). Then, when a value A obtained with the [equation 1] is larger than a threshold value a that is given in advance, received data is discarded (Step 45). Otherwise, the received data is accepted (Step 43), and the estimated channel state is stored (updated or overwritten) (Step 44).

Incidentally, for obtaining <H′>, a publicly known technique described in, for example, “Channel Estimation and Data Detection in MIMO System Using SAGE Algorithm (MIMO system niokeru SAGE algorithm wo mochiita tsushinro suitei oyobi data kenshutsu)” (Someya, Otsuki, Tokyo University of Science, Shingakugiho RSC2004-61) can be used. In the above-described example, all the data is discarded when the channel state is different largely, but the data may be discarded only when the data part is an association release request or an authentication release request.

FIG. 5 is a block diagram showing a configuration example of the access point 12 shown in FIG. 1. As shown in FIG. 5, the access point 12 has a wireless transmitting/receiving unit 12a, a communication processing unit 12b, a wired transmitting/receiving unit 12c, a channel state estimating unit 12d, a channel state storing unit 12e, and a channel state comparing unit 12f.

The wireless transmitting/receiving unit 12a performs transmission/reception of information wirelessly to/from the outside. It has a connection to the communication processing unit 12b for processing data received or to be transmitted. Further, it has a connection to the channel state estimating unit 12d for estimating a channel state from received data and derives data using a result of the estimation. The communication processing unit 12b has a connection to the wireless transmitting/receiving unit 12a as well as connections to the wired transmitting/receiving unit 12c and the channel state comparing unit 12f. The connection to the wired transmitting/receiving unit 12c is for performing necessary communication with the outside via the network 11 (FIG. 1). The connection to the channel state comparing unit 12f is for outputting a value of a transmitting end address and obtaining a comparison result for discarding/accepting data. The wired transmitting/receiving unit 12c performs transmission/reception of information to/from the outside via the network 11. It has a connection to the communication processing unit 12b for processing data received or to be transmitted.

The channel state estimating unit 12d estimates a channel state with data from the wireless transmitting/receiving unit 12a. Information of the estimated channel state is sent to the wireless transmitting/receiving unit 12a and used therein for deriving data, and is further sent to the channel state comparing unit 12f to be a comparison target. The channel state storing unit 12e stores (updates or overwrites) an estimation result of the channel state outputted from the channel state comparing unit 12f everytime. Also, the updated estimation result of the channel state is sent to the channel state comparing unit 12f as a comparison basis. The channel state comparing unit 12f searches the channel state storing unit 12e with a transmitting end address sent from the communication processing unit 12b being a key, and using stored information from this search as the basis of comparison, performs comparison of the estimation result outputted from the channel state estimating unit 12d being the comparison target. Also, the estimation result outputted from the channel state estimating unit 12d is sent to the channel state storing unit 12e as necessary. The comparison result of the channel state comparing unit 12f is provided to the communication processing unit 12b.

Describing over time, when the wireless transmitting/receiving unit 12a receives a physical frame 30 (FIG. 3) from a wireless terminal, its preamble receiving signal is sent to the channel state estimating unit 12d. The channel state estimating unit 12d estimates a channel state <H′> from the preamble receiving signal. As an algorithm for this estimation, the already described one can be used. Then, the channel state estimating unit 12d outputs the obtained estimation value <H′> to the wireless transmitting/receiving unit 12a. Using this <H′>, the wireless transmitting/receiving unit 12a receives and derives ones after the preamble in the physical frame 30, and thereby retrieves the wireless MAC frame of the data part 32 of the physical frame 30. The retrieved wireless MAC frame is sent to the communication processing unit 12b. The communication processing unit 12b sends values of a transmitting end address of the sent wireless MAC frame to the channel state comparing unit 12f.

The channel state comparing unit 12f searches the channel state storing unit 12e with the sent transmitting end address being a key to acquire a stored channel state <H′_p>, and acquires a current channel state <H′> from the channel state estimating unit 12d. Here, the channel state comparing unit 12f obtains a value A according to, for example, the [equation 1] and judges whether the channel state is changed largely or not. The result of the judgment is provided to the communication processing unit 12b, and with this result, the communication processing unit 12b whether discards or accepts the wireless MAC frame. Further, the channel state comparing unit 12f sends, when the channel state is not changed largely, the channel state <H′> acquired from the channel state estimating unit 12d with the MAC address to the channel state storing unit 12e. Accordingly, the channel state storing unit 12e stores the channel state <H′> with the MAC address over again.

Note that when the wireless MAC frame is accepted, the communication processing unit 12b performs regular processing as an access point on the wireless MAC frame. Specifically, when the wireless MAC frame is a management frame, management processing is performed. Otherwise, when the wireless MAC frame is a data frame, the wireless MAC frame is sent to a wireless terminal corresponding to its destination address via the wireless transmitting/receiving unit 12a if there is a connected relationship with that corresponding wireless terminal or the wireless MAC frame is sent to the wired transmitting/receiving unit 12c if there is no connected relationship with the wireless terminal corresponding to the destination address.

When the wired transmitting receiving unit 12c receives a packet (a communication frame flowing on Ethernet (registered trademark)) from the outside via the network 11, the wired transmitting/receiving unit 12c sends this packet to the communication processing unit 12b. The communication processing unit 12b confirms whether a connected relationship is established or not with a wireless terminal corresponding to the MAC address of the destination of the packet, and when there is a connected relationship, it is converted into a wireless MAC frame and sent to the wireless transmitting/receiving unit 12a. On the other hand, when there is no connected relationship, the sent packet is discarded. When the wireless transmitting/receiving unit 12a receives the wireless MAC frame from the communication processing unit 12b, it is converted into the format of physical frame and transmitted as radio symbols.

In the access point 12 of this embodiment, channel states is always compared when a physical frame is received, but instead if a wireless MAC frame is encrypted and thus authentication is possible, a wireless MAC frame which passed the authentication may be processed as one sent from an authorized terminal. In this case, the communication processing unit 12b confirms whether there is authentication information of the wireless MAC frame received from the wireless transmitting/receiving unit 12a, and performs authentication when there is authentication information. Then, when it passes the authentication, this is notified with a MAC address thereof to the channel state comparing unit 12f, and the channel state comparing unit 12f acquires an estimation value of a channel state from the channel state estimating unit 12d and sends it with the MAC address to the channel state storing unit 12e. The channel state storing unit 12e overwrites and stores the estimation value corresponding to the MAC address.

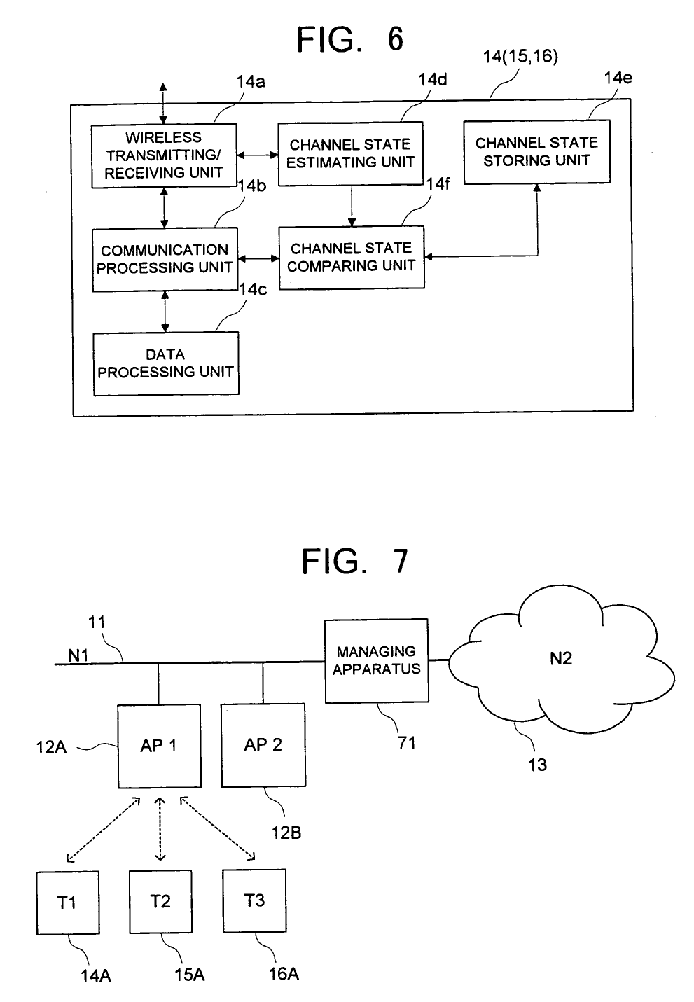

FIG. 6 is a block diagram showing a configuration example of the wireless terminal 14 (15, 16) shown in FIG. 1. As shown in FIG. 6, this wireless terminal 14 (15, 16) has a wireless transmitting/receiving unit 14a, a communication processing unit 14b, a data processing unit 14c, a channel state estimating unit 14d, a channel state storing unit 14e, and a channel state comparing unit 14f. As compared to the access point 12, the wireless terminal 14 (15, 16) is different in that it does not have the wired transmitting/receiving unit and has instead the data processing unit 14c.

The data processing unit 14c is a part in which application software operates, and depending on processing of the application software, the data processing unit 14c generates a packet (a communication frame for flowing on Ethernet (registered trademark)) when communication with the outside is necessary, and sends it to the communication processing unit 14b. When this packet is sent from the data processing unit 14c, the communication processing unit 14b confirms whether the wireless terminal 14, (15, 16) is in a connected relationship with the access point 12, and converts the packet into a wireless MAC frame and sends it to the wireless transmitting/receiving unit l4awhen it is in a connected relationship. On the other hand, when it is not in a connected relationship with the access point 12, the communication processing unit 14b discards this packet. When the wireless transmitting/receiving unit 14a receives the wireless MAC frame from the communication processing unit 14b, it converts the wireless MAC frame from the communication processing unit 14b into the form of physical frame and transmits it as radio symbols.

The operation after the wireless transmitting/receiving unit 14a receives a physical frame from the access point 12 is almost the same as the operation description of the access point 12 with reference to FIG. 5. Specifically, it is simply needed to replace the wireless transmitting/receiving unit 12a, the communication processing unit 12b, the channel state estimating unit 12d, the channel state storing unit 12e, the channel state comparing unit 12f with the wireless transmitting/receiving unit 14a, the communication processing unit 14b, the channel state estimating unit 14d, the channel state storing unit 14e, and the channel state comparing unit 14f. However, storing of the estimated channel state <H′> without the MAC address is possible since the access point 12 is fixed.

Also in the wireless terminal 14 (15, 16), it is not always necessaryto comparechannel stateswhena physical frame is received. If a wireless MAC frame is encrypted and thus authentication is possible, a wireless MAC frame which passed the authentication may be processed as one sent from an authorized access point. In this case, the communication processing unit 14b confirms whether there is authentication information of the wireless MAC frame received from the wireless transmitting/receiving unit 14a, and performs authentication when there is authentication information. Then, when it passes the authentication, this is notified to the channel state comparing unit 14f, and the channel state comparing unit 14f acquires an estimation value of a channel state from the channel state estimating unit 14d and sends it to the channel state storing unit 14e. The channel state storing unit 14e overwrites and stores the received estimation value of the channel state.

As described above, according to this embodiment, the wireless terminal 14 (15, 16) or the access point 12 can discard a frame faked by one other than the party of communicat ion in a connected relationship. Accordingly, when a faked association release request frame or authentication release request frame is received, it is possible to discard such a request frame and thereby maintain the connected relationship. Therefore, it is possible to protect against DOS (denial of service) attacks with a faked frame. Particularly, thewireless terminal 14 (15, 16) also has the function to discard faked frames, so that it is possible to cope with a case that a malicious wireless terminal impersonates an access point.

### Second Embodiment

Next, the wireless communication system according to another embodiment of the present invention will be described with reference to FIG. 7. FIG. 7 is a block diagram showing a schematic configuration of the wireless communication system according to another embodiment of the present invention. As shown in FIG. 7, this system has a network 11, access points 12A, 12B, an outside network 13, wireless terminals 14A (15A, 16A, . . . ), and a management apparatus 71. Here, the access points 12A, 12B and the management apparatus 71 are both equivalent to communication apparatuses, and the wireless terminals 14A (15A, 16A, . . . ) are equivalent to wireless communication terminals.

The access points 12A, 12B are connected to the network 11, and are capable of communicating with the outside network 13 via the network 11 and the management apparatus 71. The wireless terminal 14A (15A, 16A) is capable of connecting to the access points 12A, 12B wirelessly and thereby capable of communicating with another terminal via the access point 12A or 12B. Further, the wireless terminal 14A (15A, 16A) is capable of communicating with a terminal on the outside network 13 via the access point 12A or 12B, the network 11, and the management apparatus 71.

The same symbols are designated to already described components among these components. Descriptions of these parts are omitted. In this embodiment, the access points 12A, 12B have a function to obtain the incoming direction of a radio wave from the wireless terminal 14A (15A, 16A), which is different from the above-described embodiment. To realize the function to obtain the incoming direction of a radio wave, for example, publicly known techniques disclosed in Japanese Patent Application Laid-open No. 2003-69481 or Japanese Patent Application Laid-open No. 2003-368663 can. be used. The managing apparatus 71 is provided on the network 11 and performs estimation of positions of the wireless terminal 14A (15A, 16A) from information of the incoming direction of a radio wave sent from the access points 12A, 12B.

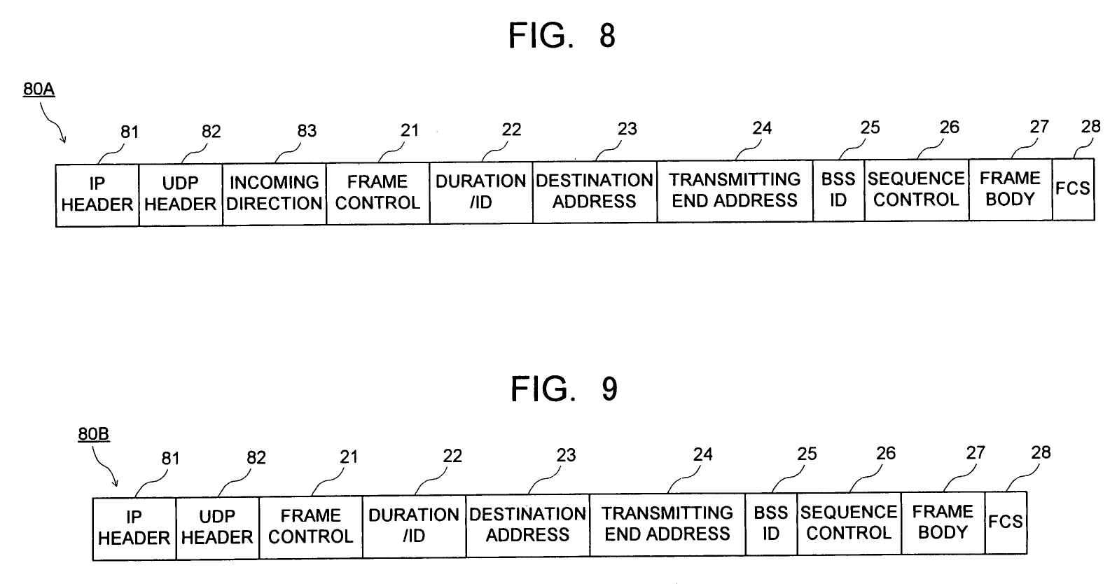

To describe the operation schematically, upon reception of a wireless MAC frame from the wireless terminal 14A (15A, 16A), the access points 12A, 12B, transmit it to the managing apparatus 71 via the network 11. When transmitting, the incoming direction of a radio wave from the wireless terminal 14A (15A, 16A) is transmitted together. FIG. 8 is a view showing a format example of an access point control frame transmitted by the access points 12A, 12B shown

the managing apparatus 71. As shown in FIG. 8, this access point control frame 80A is in a form such that an incoming direction field 83 is added to the wireless MAC frame (a part from the frame control field 21 to the FCS field 28) received from the wireless terminal 14A (15A, 16A), and a UDP header 82 and an IP header 81 are further added thereto. Values of the incoming direction field 83 can have two elements of horizontal incoming direction and vertical incoming direction.

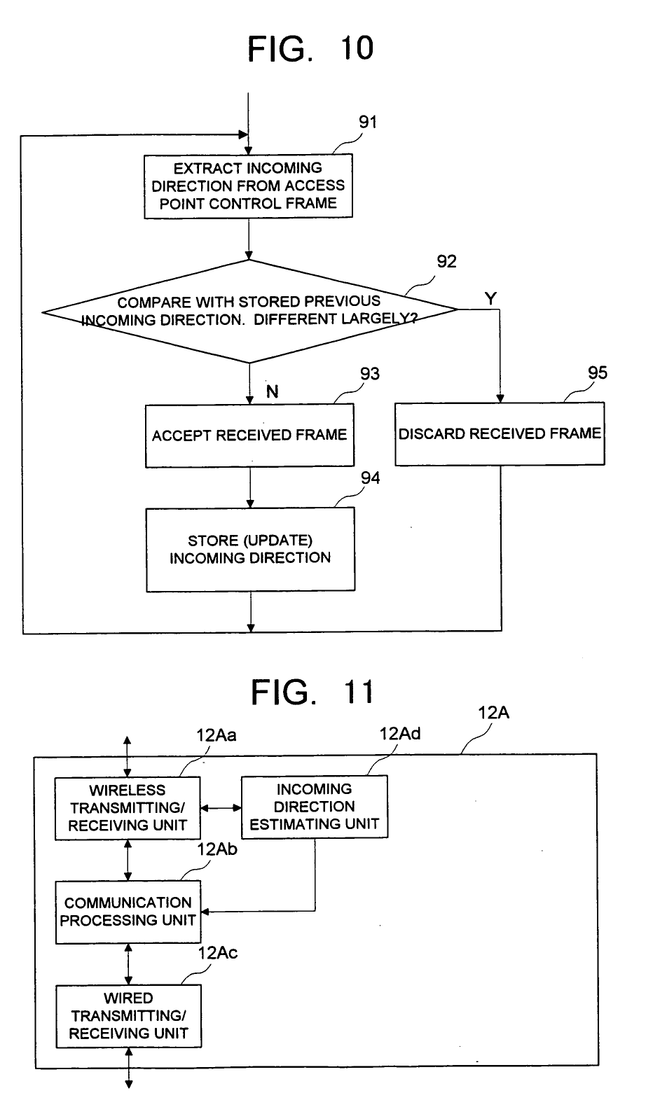

When the wireless terminal 14A (15A, 16A) attempts to perform some kind of communication, it sends an association request to the access point 12A to which it desires to be connected. This association request is received by both the access points 12A, 12B and sent from each of them as the access point control frame 80A to the managing apparatus 71. The managing apparatus 71 thereby generates an association response and transmits an access point control frame, in which a UDP header 82 and an IP header 81 are added to the frame of the association response, to predetermined one of the access points 12A and 12B (the access point 12A for example). The access point control frame at this time is in a format shown in FIG. 9. FIG. 9 is a view showing a format example of the access point control frame 80B returned by the managing apparatus 71 shown the access point 12A.

The access point 12A retrieves the association response from the access point control frame 80B from the managing apparatus 71, and transmits it to the wireless terminal 14A (15A, 16A). Accordingly, the wireless terminal 14A (15A, 16A) establishes a connected relationship with the access point 12A.

Thus, the wireless MAC frame from the wireless terminal 14A (15A, 16A) is transmitted to the managing apparatus 71 in the form of access point control frame 80A from the access points 12A and 12B. Then, the managing apparatus 71 generates a response frame thereto and transmits it in the form of access point control frame 80B to predetermined one of the access points 12A and 12B. This response frame is transmitted in the regular formby the predetermined access point to the wireless terminal 14A (15A, 16A) corresponding to the destination address field 23 (FIG. 9) in the response frame.

In the managing apparatus 71, when the access point control frame 80A is received from the access points 12A, 12B, an incoming direction is retrieved from the incoming direction field 83 therein and is compared with an incoming direction at the time of receiving a previous access point control frame. When the incoming direction is different largely from the previous frame, the received frame is discarded and no response is returned. Here, the determination of whether to discard the frame or not can be made by, for example, the following value A1.
A1=(X(n, 1)−X(n−1, 1))ˆ2+(Y(n, 1)−Y(n−1, 1))ˆ2+(X(n, 2)−X(n−1, 2))ˆ2+(Y(n, 2)−Y(n−1, 2))ˆ2
(where X (n, i) is a horizontal element of the incoming direction of an n-th access point control frame 80A sent by an access point i, and Y(n, i) is a vertical element of the incoming direction of the n-th access point control frame 80A sent by an access point i) . . . [equation 2] Here, if A1>α, data is discarded. Otherwise data is accepted. Briefly speaking, this is to identify and use the position of the wireless terminal 14A (15A, 16A) by means of triangulation with the access points 12A, 12B which are placed at different locations.

Description of the above operation in a flow is shown in FIG. 10. FIG. 10 is a flowchart showing a schematic flow of the operation of themanaging apparatus 71 shown in FIG.7. Specifically, upon reception of the access point control frames 80A from the access points 12A, 12B, the managing apparatus 71 retrieves the incoming direction fields 83 (step 91), and obtains a value A1 from them and stored previous incoming directions according to the equation 2. Here, when the obtained value A1 is larger than a threshold value al given in advance (Y in Step 92), the received data is discarded (Step 95). Otherwise, the received data is accepted (Step 93), and estimated incoming directions are stored (updated or overwritten) (Step 94).

In the above-described example, all data is discarded when incoming directions are different largely, but the data may be discarded only when the data part is an association release request or an authentication release request.

According to this embodiment also, it is possible to discard a wireless MAC frame transmitted from a location different from that of an authorized wireless terminal, and thus the access point 12A (12B) will not be released from a connected relationship by a packet faked by a terminal other than the terminal with which the communication is being performed.

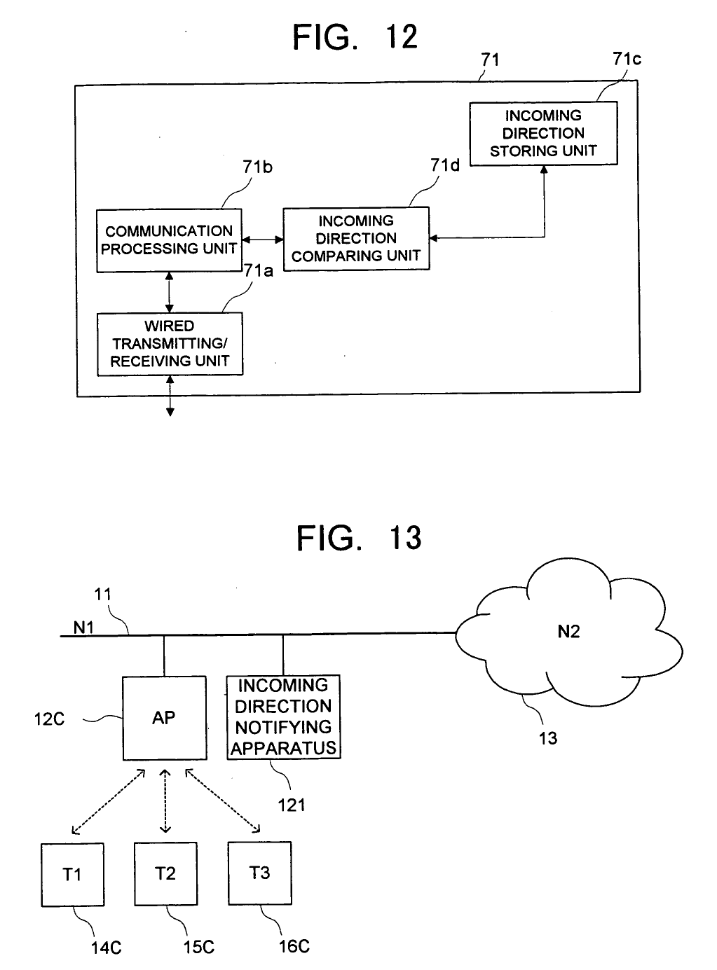

FIG. 11 is a block diagram showing a configuration example of the access points 12A, 12B shown in FIG. 7. As shown in FIG. 11, the access point 12A (12B) has awireless transmitting/receiving unit 12Aa, a communication processing unit 12Ab, a wired transmitting/receiving unit 12Ac, and an incoming direction estimating unit 12Ad.

The wireless transmitting/receiving unit 12Aa performs transmission/reception of information to/from the outside wirelessly. It has a connection to the communication processing unit 12Ab for processing transmitted data received or to be transmitted. Further, is has a connection to an incoming direction estimating unit 12Ad for estimating the radio wave incoming direction of the received data. The communication processing unit 12Ab has a connection to the wireless transmitting/receiving unit 12Aa as well as connections to the wired transmitting/receiving unit 12Ac and the incoming direction estimating unit 12Ad. The connection to the wired transmitting/receiving unit 12Ac is for performing necessary communication with the outside via the network 11 (FIG. 7). The connection to the incoming direction estimating unit 12Ad is for obtaining an estimated incoming direction.

The wired transmitting/receiving unit 12Ac performs transmission/reception of information to/from the outside via the network 11. It has a connection to the communication processing unit 12Ab for processing of data received or to be transmitted. The incoming direction estimating unit 12Ad estimates the incoming direction of a radio wave by radio wave information from the wireless transmitting/receiving unit 12Aa. Information of the estimated incoming direction is sent to the communication processing unit 12Ab and used for generating the access point control frame 80A (FIG. 8).

Describing over time, when the wireless transmitting/receiving unit 12Aa receives a wireless MAC frame from a wireless terminal, it sends radio wave information at this moment to the incoming direction estimating unit 12Ad and also sends the wireless MAC frame to the communication processing unit 12Ab. Here, the radio wave information includes, for example, the pointing direction of an antenna with respect to an input radio wave and radio wave intensity at this moment. The incoming direction estimating unit 12Ad estimates the incoming direction of the input radio wave from the radio wave information and sends the estimated incoming direction to the communication processing unit 12Ab.

The communication processing unit 12Ab adds the incoming direction field 83 to the wireless MAC frame and further adds the UDP header 82 and the IP header 81 thereto to generate the access point control frame 80A. The generated access point control frame 80A is sent to the wired transmitting/receiving unit 12Ac. Here, a destination port number of UDP and a destination IP address are set in advance. The wired transmitting/receiving unit 12Ac transmits the received access point control frame 80A to the managing apparatus 71 via the network 11.

When the wired transmitting/receiving unit 12Ac receives the access point control frame 80B from the managing apparatus 71, thewiredtransmitting/receivingunitAcsendsittothecommunication processing unit 12Ab. The communication processing unit 12Ab generates a wireless MAC frame by removing the IP header 81 and the UDP header 82 from this access point control frame 80B, and sends it to the wireless transmitting/receiving unit 12Aa if the access point 12A (12B) is in connected relationship with a wireless terminal corresponding to the destination address field 23 (FIG. 9). The wireless transmitting/receiving unit 12Aa transmits the sent wireless MAC frame to a wireless terminal described in the destination address. If the access point 12A (12B) is not in connected relationship with a wireless terminal corresponding to the destination address field 23 (FIG. 9), the wireless MAC frame is transmitted to the network 11 (FIG. 7) via the wired transmitting/receiving unit 12Ac.

FIG. 12 is a block diagram showing a configuration example of the managing apparatus 71 shown in FIG. 7. As shown in FIG. 12, the managing apparatus 71 has a wired transmitting/receiving unit 71a, a communication processing unit 71b, an incoming direction comparing unit 71d, and an incoming direction storing unit 71c.

The wired transmitting/receiving unit 71a performs transmission/reception of information to/from the outside (including the access points 12A, 12B) via the network 11 (FIG. 7). It has a connection to the communication processing unit 71b for processing data received or to be transmitted. The communication processing unit 71b has a connection to the wired transmitting/receiving unit 71a as well as a connection to the incoming direction comparing unit 71d. The connection to the incoming direction comparing unit 71d is for sending values of a transmitting end address and an incoming direction thereof and for obtaining a comparing result for discarding/accepting a received frame.

The incoming direction comparing unit 71d searches the incoming direction storing unit 71c with a transmitting end address sent from the communication processing unit 71b being a key, and using stored information resulting from this search as the basis of comparison, performs comparison of an incoming direction sent from the communication processing unit 71b being the comparison target. The comparison result is provided to the communication processing unit 71b. The incoming direction storing unit 71c stores (updates or over writes) values of the incoming direction sent from the incoming direction comparing unit 71d every time.

Describing over time, when the wired transmitting/receiving unit 71a receives access point control frames 80A (FIG. 8) from the access points 12A, 12B, they are sent to the communication processing unit 71b. From the sent access point control frames 80A, the communication processing unit 71b retrieves incoming directions and transmitting end addresses in wireless MAC frames, and transmits them to the incoming direction comparing unit 71d. From the incoming directions and the transmitting end addresses from both the access points 12A, 12B, the incoming direction comparing unit 71d retrieves incoming directions stored in the incoming direction storing unit 71c with these transmitting end addresses being keys, compares the stored incoming directions and the incoming directions received at this time from the communication processing unit 71b and judges whether the incoming directions are different largely or not. This judgment can be performed by obtaining a value A1 according to, for example, the [equation 2].

The incoming direction comparing unit 71d notifies the communication processing unit 71b of prohibition of response when the incoming directions are different largely, or notifies the communication processing unit 71b of permission of response when the incoming directions are not different largely. Upon reception of the response permission notification, the communication processing unit 71b starts processing of the wireless MAC frames intheaccesspointcontrol frames 80A. Whenthewireless MAC frames are control frames or management frames, the same processing as that performed normally by an access point is performed, and a corresponding response message is generated. For example, when a received wireless MAC frame is an association request, an association response frame is generated. To the generated wireless MAC frame, the UDP header 82 and the IP header 81 are added, which becomes the form of access point control frame 80B. This is sent to the wired transmitting/receiving unit 71a. The destination port number of UDP and the destination IP address at this moment are set in advance.

Further, when the communication processing unit 71b receives the association release request, an association release response frame is generated. To the generated wireless MAC frame, the UDP header 82 and the IP header 81 are added, which becomes the form of access point control frame 80B. This is sent to the wired transmitting/receiving unit 71a. The access point control frame 80B receivedbythewiredtransmitting/receivingunit7laisoutputted to the network 11 (FIG. 7).

Note that when the comparison results in the incoming direction comparing unit 71d are not different largely, the incoming directions and the transmitting end addresses from the access points 12A, 12B at this time are sent to the incoming direction storing unit 71c. Thus, the incoming direction storing unit 71c stores (updates or overwrites) these incoming directions with the respective transmitting end address.

As described above, in this embodiment, the managing apparatus 71 estimates a terminal position by performing processing intensely by means of triangulation while functions to be added to each of the access points 12A, 12B are suppressed to be small, and consequently a frame faked by one other than the party of communication in a connected relationship can be discarded. Thus, when a faked association release request frame or authentication release request frame is received, it is possible to discard such a request frame and thereby maintain the connected relationship. Note that there is no addition of any special configuration to the wireless terminal 14A (15A, 16A) side, and they do not have a function to discard an unauthorized packet.

### Third Embodiment

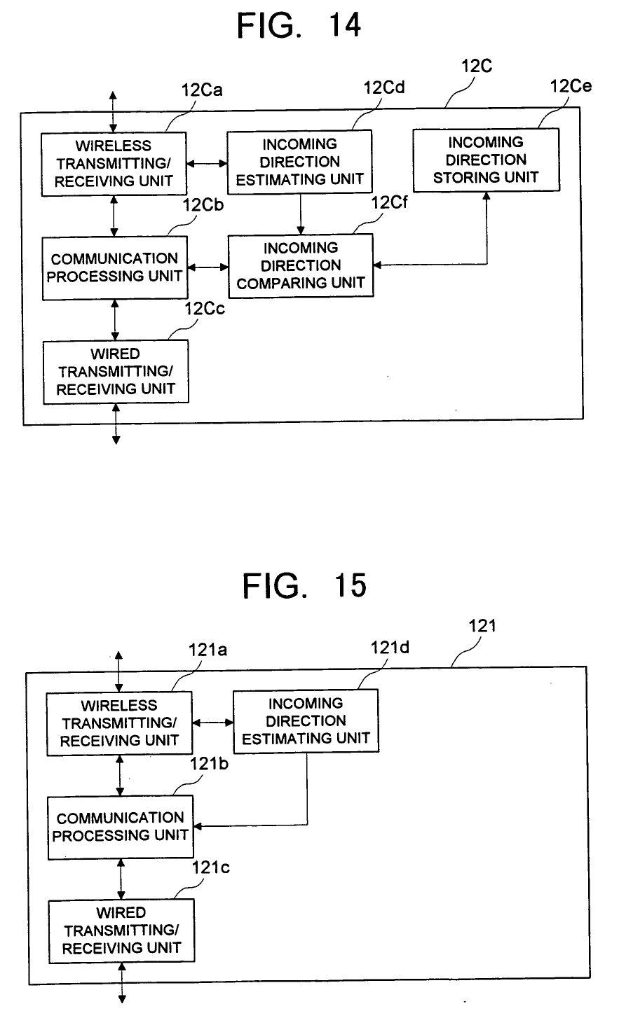

Next, a wireless communication system according to still another embodiment of the present invention will be described with reference to FIG. 13. FIG. 13 is a block diagram showing a schematic configuration of the wireless communication system according to still another embodiment of the present invention. As shown in FIG. 13, this system has a network 11, an access point 12C, an outside network 13, wireless terminals 14C (15C, 16C, . . . ), and an incoming direction notifying apparatus 121. Here, the access point 12C and the incoming direction notifying apparatus 121 are equivalent to communication apparatuses, and the wireless terminals 14C (15C, 16C, . . . ) are equivalent to wireless communication terminals.

The access point 12C is connected to the network 11 and is capable of communicating with the outside network 13 and the incoming direction notifying apparatus 121 via the network 11. The wireless terminal 14C (15C, 16C) is capable of connecting to the access point 12C wirelessly and thereby capable of communicating via the access point 12C with another terminal. Further, thewireless terminal 14C (15C, 16C) is capable of communicating with a terminal on the outside network 13 via the access point 12C and the network 11. The incoming direction notifying apparatus 121 is connected to the network 11 and is capable of communicating with the outside network 13 and the access point 12C via the network 11. Further, the incoming direction notifying apparatus 121 has a function to receive wireless communication from the wireless terminal 14C (15C, 16C) and to determine the incoming direction of its radio wave.

The same symbols are designated to already described components among these components. Descriptions of these parts are omitted. In this embodiment, the access points 12C and the incoming direction notifying apparatus 121 have a function to determine the incoming direction of a radio wave from the wireless terminals 14C (15C, 16C). To realize the function to determine the incoming direction of a radio wave, publicly known techniques disclosed in Japanese Patent Laid-open Application No. 2003-69481 or Japanese Patent Laid-openApplication No. 2003-368663 can be used for example.

To describe the operation schematically, upon reception of a frame from the wireless terminal 14C (15C, 16C), the incoming direction notifying apparatus 121 transmits it to the access point 12C via the network 11. When transmitting, the incoming direction of a radio wave from the wireless terminal 14C (15C, 16C) is transmitted together. An access point control frame in this case can be the same as the already-described format shown in FIG. 8.

When the wireless terminal 14C (15C, 16C) attempts to perform some kind of communication, it sends an association request to the access point 12C to which it desires to be connected. This association request is received by the access point 12C and also by the incoming direction notifying apparatus 121. The incoming direction notifying apparatus 121 sends a received wireless MAC frame as an access point control frame 80A to the access point 12C.

Upon reception of the access point control frame 80A from the incoming direction notifying apparatus 121, the access point 12C retrieves the incoming direction therein, and compares it and the incoming direction of a radio wave at the time it received the wireless MAC frame with an incoming direction at the time of receiving a previous wireless MAC frame. When the incoming directions are different largely from the previous frame, the received frame is discarded and no response is returned. Here, the determination of whether to discard the frame or not can be made by, for example, calculating a value A1 of the already-described [equation 2].

Also in this embodiment, the access point 12C is able to discard a wireless MAC frame transmitted from a location different from those of the wireless terminals 14C (15C, 16C). The access point 12C will not be released from a connected relationship with a terminal with which the communication is performed by a packet faked by another terminal.

FIG. 14 is a block diagram showing a configuration example of the access point 12C shown in FIG. 13. As shown in FIG. 14, this access point 12C has a wireless transmitting/receiving unit 12Ca, a communication processing unit 12Cb, a wired transmitting/receiving unit 12Cc, an incoming direction estimating unit 12Cd, an incoming direction storing unit 12Ce, and an incoming direction comparing unit 12Cf.

The wireless transmitting/receiving unit 12Ca performs transmission/reception of information to/from the outside wirelessly. It has a connection to the communication processing unit l2Cb for processing data received or to be transmitted. Further, it has a connection to the incoming direction estimating unit 12Cd for estimating the radio wave incoming direction of the received data. The communication processing unit 12Cb has a connection to the wireless transmitting/receiving unit 12Ca as well as connections to the wired transmitting/receiving unit 12Cc and the incoming direction comparing unit 12Cf. The connection to the wired transmitting/receiving unit 12Cc is for performing necessary communication with the outside via the network 11 (FIG. 13). The connection to the incoming direction comparing unit 12Cf is for sending a transmitting end address and values of an incoming direction thereof and obtaining comparison results for discarding/accepting a received frame.

The wired transmitting/receiving unit 12Cc performs transmission/reception of information to/from the outside via the network 11. It has a connection to the communication processing unit 12Cb for processing of data received or to be transmitted. The incoming direction estimating unit 12Cd estimates the incoming direction of a radio wave by radio wave information from the wireless transmitting/receiving unit 12Ca. Information of the estimated incoming direction is sent to the incoming direction comparing unit 12Cf to be a comparing target.

The incoming direction comparing unit 12Cf searches the incoming direction storing unit 12Ce with a transmitting end address sent from the communication processing unit 12Cb being a key, and using stored information resulting from this search as the basis of comparison, performs comparison of an incoming direction sent from the communication processing unit 12Cb being the comparison target. The comparison result is provided to the communication processing unit 12Cb. The incoming direction storing unit 12Ce stores (updates or overwrites) values of the incoming direction sent from the incoming direction comparing unit 12Cf every time.

Describing over time, when the wireless transmitting/receiving unit 12Ca receives a wireless MAC frame from the wireless terminal 14C (15C, 16C), it is sent to the communication processing unit 12Cb, and also radio wave information is sent to the incoming direction estimating unit 12Cd. Here, the radio wave information includes, for example, the pointing direction of an antenna with respect to an input radio wave and radio wave intensity at this moment. The incoming direction estimating unit 12Cd estimates the incoming direction of the input radio wave from the radio wave information and sends the estimated incoming direction to the incoming direction comparing unit 12Cf.

On the other hand, when the wired transmitting/receiving unit 12Cc receives an access point control frame 80A (FIG. 8) from the incoming direction notifying apparatus 121, it is sent to the communication processing unit 12Cb. Upon reception of this access point control frame 80A, the communication processing unit 12Cb retrieves an incoming direction included therein and a transmitting end address in the wireless MAC frame and sends them to the incoming direction comparing unit 12Cf. The incoming direction comparing unit 12Cf estimates the current location of the wireless terminal 14C (15C, 16C) from the incoming direction received from the communication processing unit 12Cb and the incoming direction received from the incoming direction estimating unit 12Cd, and compares it with the information of incoming direction stored in the incoming direction storing unit 12Ce searched with the transmitting end address being a key as the basis. For example, the already-described [equation 2] is used to judge whether the incoming directions are different largely or not.

With this judgment, a response permission instruction is sent when the incoming directions are not different largely or a responseprohibitioninstructionissentwhentheincomingdirections are different largely to the communication processing unit 12Cb respectively. Note that when the comparison result in the incoming direction comparing unit 12Cf is not different largely, the incoming direction comparing unit 12Cf sends the incoming direction and the transmitting end address received from the communication processing unit 12Cb and the incoming direction received from the incoming direction estimating unit 12Cd to the incoming direction storing unit 12Ce. Thus, the incoming direction storing unit 12Ce stores (updates or overwrites) these incoming directions with the respective transmitting end address.

When the communication processing unit 12Cb receives the instruction of response permission from the incoming direction comparing unit 12Cf, it continues normal processing as an access point. For example, when the received wireless MAC frame is an association request, an association response frame is generated and sent to the wireless transmitting/receiving unit 12Ca. Otherwise, when an association release request is received, an association release response frame is generated, and the generated wireless MAC frameissenttothewirelesstransmitting/receivingunitl2Ca. When the wireless transmitting/receiving unit 12Ca receives the wireless MAC frame from the communication processing unit 12Cb, it transmits this wireless MAC frame wirelessly.

FIG. 15 is a block diagram showing a configuration example of the incoming direction notifying apparatus 121 shown in FIG. 13. As shown in FIG. 15, this incoming direction notifying apparatus 121 has a wireless transmitting/receiving unit 121a, a communication processing unit 121b, a wired transmitting/receiving unit 121c, and an incoming direction estimating unit 121d.

The wireless transmitting/receiving unit 121a performs transmission/reception of information to/from the outside wirelessly. It has a connection to the communication processing unit 121b for processing data received or to be transmitted. Further, is has a connection to the incoming direction estimating unit 121d for estimating the radio wave incoming direction of the received data. The communication processing unit 121b has a connection to thewireless transmitting/receivingunit 121a as well as connections to the wired transmitting/receiving unit 121c and the incoming direction estimating unit 121d. The connection to the wired transmitting/receiving unit 121c is for performing necessary communication with the outside via the network 11 (FIG. 13). The connection to the incoming direction estimating unit 121d is for obtaining an estimated incoming direction.

The wired transmitting/receiving unit 121c performs transmission/reception of information to/from the outside via the network 11. It has a connection to the communication processing unit 121b for processing of data received or to be transmitted. The incoming direction estimating unit 121d estimates the incoming direction of a radio wave by radio wave information from the wireless transmitting/receiving unit 121a. Information of the estimated incoming direction is sent to the communication processing unit 121b and used for generation of the access point control frame 80A (FIG. 8).

Describing over time, when the wireless transmitting/receiving unit 121a receives a wireless MAC frame from a wireless terminal, it sends radio wave information at this moment to the incoming direction estimating unit 121d and also sends the wireless MAC frametothecommunicationprocessingunit 121b. Here, the radio wave information includes, for example, the pointing direction of an antenna with respect to an input radio wave and radio wave intensity at this moment. The incoming direction estimating unit 121d estimates the incoming direction of the input radio wave from the radio wave information and sends the estimated incoming direction to the communication processing unit 121b.

The communication processing unit 121b adds an incoming direction field 83 to the wireless MAC frame and further adds a UDP header 82 and an IP header 81 thereto to generate an access point control frame 80A. The generated access point control frame 80A the wired transmitting/receiving unit 121c. Here, a destination port number of UDP and a destination IP address are set in advance. The wired transmitting/receiving unit 121c transmits the received access point control frame 80A to the access point 12C via the network 11.

As described above, in this embodiment, without requiring anapparatuswhich intenselyperforms processingsuchas themanaging apparatus 71 (FIG. 7), a terminal position is estimated by means of triangulation, and consequently a frame faked by one other than the party of communication in a connected relationship can be discarded. Thus, when a faked association release request frame or authentication release request frame is received, it is possible to discard such a request frame and thereby maintain the connected relationship. Note that there is no addition of any special configuration to the wireless terminal 14C (15C, 16C) side, and they do not have a function to discard an unauthorized packet.

### Other Embodiments

In the above-described first to third embodiments, each wireless terminal may be configured to transmit, for example, a null function frame (type 10 and sub-type 0100 of frame control field) periodically. Thereby, even when a wireless terminal is moving, an access point can follow the moving, and thus it is possible to prevent discarding of a packet from the wireless terminal caused by judgment (misjudgment) of a channel state or an incoming direction to be largely different.

Alternatively, the wireless terminal 14 (15, 16) in the first embodiment may be configured to transmit, when a channel state with the access point 12 is different largely from a threshold value β, a null function frame (type 10 and sub-type 0100 of frame control field) for example. It is preferred that β is smaller than α for the. [equation 1]. The access point transmits a beacon frame periodically, so that the wireless terminal 14 (15, 16) can detect movement of itself or the access point 12 using β. Thus, for example, by transmitting a null function frame, the access point 12 can update values of its channel state storing unit 12e. Accordingly, even when a wireless terminal is moving, the access point 12 can follow the moving, and thus it is possible to prevent discarding of a packet from the wireless terminal 14 (15, 16) caused by judgment (misjudgment) of a channel state to be largely different.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus, comprising:
an estimating unit which estimates a first wireless channel state from a first frame wirelessly received and a second wireless channel state from a second frame wirelessly received after the first frame;
a storing unit capable of storing the first wireless channel state as a past wireless channel state;
a comparing unit which compares a difference between the second wireless channel state and the past wireless channel state with a threshold value; and
a processing unit which discards the second frame when the difference is larger than the threshold value.

2. The communication apparatus as set forth in claim 1,
wherein the storing unit stores the second wireless channel state as the past wireless channel state when the difference is not larger than the threshold value.

3. A wireless communication terminal, comprising:
an estimating unit which estimates a first wireless channel state from a first frame wirelessly received and a second wireless channel state from a second frame wirelessly received after the first frame;
a storing unit capable of storing the first wireless channel state as a past wireless channel state;
a comparing unit which compares a difference between the second wireless channel state and the past wireless channel state with a first threshold value; and
a processing unit which discards the second flame when the difference is larger than the first threshold value.

4. The wireless communication terminal as set forth in claim 3,
wherein the storing unit stores the second wireless channel state as the past wireless channel state when the difference is not larger than the first threshold value.

5. The wireless communication terminal as set forth in claim 3, further comprising:
a transmitting/receiving unit capable of wirelessly transmitting a third frame periodically.

6. The wireless communication terminal as set forth in claim 3,
wherein the estimating unit further estimates a third wireless channel state from a beacon frame wirelessly received after the first frame, and
wherein the comparing unit further compares a second difference between the third wireless channel state and the past wireless channel state with a second threshold value which is smaller than the first threshold value, and
further comprising a transmitting/receiving unit which wirelessly transmits a third frame when the second difference is larger than the second threshold value.

7. A wireless communication system, comprising:
a communication apparatus which has a first estimating unit which estimates a first wireless channel state from a first frame wirelessly received and a second wireless channel state from a second frame wirelessly received after the first frame, a first storing unit capable of storing the first wireless channel state as a first past wireless channel state, a first comparing unit which compares a first difference between the second wireless channel state and the first past wireless channel state with a first threshold value, and a first processing unit which discards the second frame when the first difference is larger than a first threshold value; and
a terminal which has a second estimating unit which estimates a third wireless channel state from a third frame wirelessly received and a fourth wireless channel state from a fourth frame wirelessly received after the third frame, a second storing unit capable of storing the third wireless channel state as a second past wireless channel state, a second comparing unit which compares a second difference between the fourth wireless channel state and the second past wireless channel state with a second threshold value, and a second processing unit which discards the fourth frame when the second difference is larger than a second threshold value,
wherein the communication apparatus wirelessly transmits the third frame and the fourth frame, and
wherein the terminal wirelessly transmits the first frame and the second frame.

8. A wireless communication method, comprising:
estimating a first wireless channel state by an estimating unit from a first frame wirelessly received and a second wireless channel state by the estimating unit from a second frame wirelessly received after the first frame;
storing the first wireless channel state as a past wireless channel state;
comparing a difference between the second wireless channel state and the past wireless communication with a threshold value; and
discarding the second frame when the difference is larger than the threshold value.

9. A communication apparatus, comprising:
an estimating unit which estimates a radio wave incoming direction from a condition of a radio wave wirelessly received;
a processing unit which creates a frame including the radio wave incoming direction; and
a transmitting/receiving unit which transmits the frame via wired transmission.

10. A communication apparatus connectable to two access points via wired transmission, comprising:
a storing unit capable of storing first radio wave incoming directions, as past radio wave incoming directions, included in first frames transmitted via the wired transmission from the two access points respectively;
a comparing unit which compares a difference between a first terminal location by the past radio wave incoming directions and a second terminal location by second radio wave incoming directions included in second frames transmitted via the wired transmission from the two access points after the first frames with a threshold value;
a processing unit which creates a reply frame for the second frames only when the difference is not larger than a threshold value; and
a transmitting/receiving unit which transmits the reply frame via the wired transmission to predetermined one of the two access points.

11. The communication apparatus as set forth in claim 10,
wherein the storing unit stores the second radio wave incoming directions as the past radio wave incoming directions when the difference is not larger than the threshold value.

12. A wireless communication system, comprising:
first and second communication apparatuses each of which has an estimating unit which estimates a first radio wave incoming direction from a first condition of a first radio wave wirelessly received and a second radio wave incoming direction from a second condition of a second radio wave wirelessly received after the first radio wave, a processing unit which creates a first frame including the first radio wave incoming direction and a second frame including the second radio wave incoming direction, and a transmitting/receiving unit which transmits the first frame via wired transmission and the second frame via wired transmission respectively, the first and second communication apparatuses being placed at locations different from each other; and
a third communication apparatus which comprises a storing unit capable of storing the first radio wave incoming directions, as past radio wave incoming directions, included in the first frames transmitted via wired transmission from the first and second communication apparatuses respectively, an comparing unit which compares a difference between a first terminal location by the past radio wave incoming directions and a second terminal location by the second radio wave incoming directions included in the second frames with a threshold value, a processing unit which creates a reply frame for the second frames only when the difference is not larger than the threshold value, and a transmitting/receiving unit which transmits the reply frame via wired transmission to predetermined one of the first and second communication apparatuses.

13. A wireless communication method, comprising:
in first and second communication apparatuses placed at locations different from each other, estimating a first radio wave incoming direction from a first condition of a first radio wave wirelessly received and a second radio wave incoming direction from a second condition of a second radio wave wirelessly received after the first radio wave, creating a first frame including the first radio wave incoming direction and a second frame including the second radio wave incoming direction, and transmitting the first frame via wired transmission and the second frame via wired transmission respectively;
storing the first radio wave incoming directions, as past radio wave incoming directions, included in the first frames transmitted via wired transmission from the first and second communication apparatuses respectively;
comparing a difference between a first terminal location by the past radio wave incoming directions and a second terminal location by the second radio wave incoming directions included in the second frames with a threshold value;
creating a reply frame for the second frames only when the difference is not larger than the threshold value; and
transmitting the reply frame via wired transmission to predetermined one of the first and second communication apparatuses.

14. A communication apparatus, comprising:
an estimating unit which estimates a first radio wave incoming direction from a first condition of a first radio wave wirelessly received and a second radio wave incoming direction from a second condition of a second radio wave wirelessly received after the first radio wave;
a storing unit capable of storing the first radio wave incoming direction and a third radio wave incoming direction included in a first frame transmitted via wired transmission as past radio wave incoming directions;
a comparing unit which compares a difference between a first terminal location by the past radio wave incoming directions and a second terminal location by the second radio wave incoming direction and a fourth radio wave incoming direction included in a second frame transmitted via wired transmission after the first frame with a threshold value; and
a processing unit which discards information included in the second radio wave when the difference is larger than a threshold value.

15. The communication apparatus as set forth in claim 14,
wherein the storing unit stores the second radio wave incoming direction and the fourth radio wave incoming direction as the past radio wave incoming directions when the difference is not larger than the threshold value.

16. A wireless communication system, comprising:
a first communication apparatus which has a first estimating unit which estimates a first radio wave incoming direction from a first condition of a first radio wave wirelessly received and a second radio wave incoming direction from a second condition of a second radio wave wirelessly received after the first radio wave, a first processing unit which creates a first frame including the first radio wave incoming direction and a second frame including the second radio wave incoming direction, and a transmitting/receiving unit which transmits the first frame via wired transmission and the second frame via wired transmission respectively; and
a second communication apparatus which is located at a position different from the first communication apparatus and has a second estimating unit which estimates a third radio wave incoming direction from a third condition of a third radio wave wirelessly received and a fourth radio wave incoming direction from a fourth condition of a fourth radio wave wirelessly received after the third radio wave, an storing unit capable of storing the third radio wave incoming direction and the first radio wave incoming direction included in the first frame transmitted via wired transmission from the first communication apparatus as past radio wave incoming directions, an comparing unit which compares a difference between a first terminal location by the past radio wave incoming directions and a second terminal location by the fourth radio wave incoming direction and the second radio wave incoming direction included in the second frame transmitted via wired transmission with a threshold value, and a second processing unit which discards information included in the second radio wave when the difference is larger than a threshold value.

17. A wireless communication method, comprising:
in a first communication apparatus, estimating a first radio wave incoming direction from a first condition of a first radio wave wirelessly received and a second radio wave incoming direction from a second condition of a second radio wave wirelessly received after the first radio wave, creating a first frame including the first radio wave incoming direction and a second frame including the second radio wave incoming direction, and transmitting the first frame via wired transmission and the second frame via wired transmission respectively; and
in a second communication apparatus which is located at a position different from the first communication apparatus, estimating a third radio wave incoming direction from a third condition of a third radio wave wirelessly received and a fourth radio wave incoming direction from a fourth condition of a fourth radio wave wirelessly received after the third radio wave, storing the third radio wave incoming direction and the first radio wave incoming direction included in the first frame transmitted via wired transmission from the first communication apparatus as past radio wave incoming directions, comparing a difference between a first terminal location by the past radio wave incoming directions and a second terminal location by the fourth radio wave incoming direction and the second radio wave incoming direction included in the second frame transmitted via wired transmission with a threshold value, and discarding information included in the second radio wave when the difference is larger than a threshold value.
